(19) United States
(12) Patent Application Publication
(10) Pub. No.: US 2016/0181604 A1
(43) Pub. Date: Jun. 23, 2016

(54) SYSTEMS AND METHODS FOR LITHIUM TITANATE OXIDE (LTO) ANODE ELECTRODES FOR LITHIUM ION BATTERY CELLS

(71) Applicant: Johnson Controls Technology Company, Holland, MI (US)

(72) Inventors: Yongkyu Son, Glendale, IL (US); Bernhard M. Metz, Milwaukee, WI (US); Junwei Jiang, Whitefish Bay, WI (US); Boutros Hallac, Franklin, WI (US)

(21) Appl. No.: 14/596,624

(22) Filed: Jan. 14, 2015

Related U.S. Application Data
(60) Provisional application No. 62/049,902, filed on Sep. 12, 2014.

(51) Int. Cl. H01M 4/485; H01M 10/0525; H01M 4/04; H01M 10/06; H01M 10/42; H01M 4/62; H01M 16/00

(52) U.S. Cl. CPC H01M 4/485; H01M 4/623; H01M 4/625; H01M 10/0525; H01M 16/00; H01M 10/06; H01M 10/425; H01M 4/0409; H01M 2220/20

(57) ABSTRACT

The present disclosure relates generally to the field of lithium ion batteries and battery modules. More specifically, the present disclosure relates to a battery module including a lithium ion battery cell having a cathode with a cathode active layer and an anode with an anode active layer. The anode active layer includes at least one polyvinylidene fluoride (PVDF) binder, a conductive carbon, and a secondary lithium titanate oxide (LTO), wherein the secondary LTO includes secondary LTO particles having an average particle size (D₅₀) greater than 2 micrometers (μm).

### CROSS REFERENCE

This application claims priority from and the benefit of U.S. Provisional Application Ser. No. 62/049,902, entitled “LTO ANODE ELECTRODE FOR HIGH LOADING TO ACCOMPLISH HIGH ENERGY AND POWER CELL,” filed Sep. 12, 2014, which is hereby incorporated by reference in its entirety for all purposes.

### BACKGROUND

The present disclosure relates generally to the field of lithium ion batteries and battery modules. More specifically, the present disclosure relates to lithium ion batteries that use lithium titanate oxide (LTO) as the anode active material.

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

A vehicle that uses one or more battery systems for providing all or a portion of the motive power for the vehicle can be referred to as an xEV, where the term “xEV” is defined herein to include all of the following vehicles, or any variations or combinations thereof, that use electric power for all or a portion of their vehicular motive force. For example, xEVs include electric vehicles (EVs) that utilize electric power for all motive force. As will be appreciated by those skilled in the art, hybrid electric vehicles (HEVs), also considered xEVs, combine an internal combustion engine propulsion system and a battery-powered electric propulsion system, such as 48 volt or 130 volt systems. The term HEV may include any variation of a hybrid electric vehicle. For example, full hybrid systems (FHEVs) may provide motive and other electrical power to the vehicle using one or more electric motors, using only an internal combustion engine, or using both. In contrast, mild hybrid systems (MHEVs) disable the internal combustion engine when the vehicle is idling and utilize a battery system to continue powering the air conditioning unit, radio, or other electronics, as well as to restart the engine when propulsion is desired. The mild hybrid system may also apply some level of power assist, during acceleration for example, to supplement the internal combustion engine. Mild hybrids are typically 96 V to 130 V and recover braking energy through a belt or crank integrated starter generator. Further, a micro-hybrid electric vehicle (mHEV) also uses a “Stop-Start” system similar to the mild hybrids, but the micro-hybrid systems of a mHEV may or may not supply power assist to the internal combustion engine and operates at a voltage below 60 V. For the purposes of the present discussion, it should be noted that mHEVs typically do not technically use electric power provided directly to the crankshaft or transmission for any portion of the motive force of the vehicle, but an mHEV may still be considered as an xEV since it does use electric power to supplement a vehicle's power needs when the vehicle is idling with internal combustion engine disabled and recovers braking energy through an integrated starter generator. In addition, a plug-in electric vehicle (PEV) is any vehicle that can be charged from an external source of electricity, such as wall sockets, and the energy stored in the rechargeable battery packs drives or contributes to drive the wheels. PEVs are a subcategory of EVs that include all-electric or battery electric vehicles (BEVs), plug-in hybrid electric vehicles (PHEVs), and electric vehicle conversions of hybrid electric vehicles and conventional internal combustion engine vehicles.

xEVs as described above may provide a number of advantages as compared to more traditional gas-powered vehicles using only internal combustion engines and traditional electrical systems, which are typically 12 V systems powered by a lead acid battery. For example, xEVs may produce fewer undesirable emission products and may exhibit greater fuel efficiency as compared to traditional internal combustion vehicles and, in some cases, such xEVs may eliminate the use of gasoline entirely, as is the case of certain types of EVs or PEVs.

As technology continues to evolve, there is a need to provide improved power sources, particularly battery modules, for such vehicles. For example, it may be desirable to improve the power density, the low temperature performance, the high temperature performance, and/or the calendar life of lithium ion battery modules in order to effectively meet the power demands of an xEV. Further, it may also be desirable to improve efficiency during the manufacture of such lithium ion battery modules in order to reduce manufacturing time, reduce costs, improve robustness, and improve yields.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure relates to a battery module including a lithium ion battery cell having a cathode with a cathode active layer and an anode with an anode active layer. The anode active layer includes at least one polyvinylidene fluoride (PVDF) binder, a conductive carbon, and a secondary lithium titanate oxide (LTO), wherein the secondary LTO includes secondary LTO particles having an average particle size (D₅₀) greater than 2 micrometers (μm).

The present disclosure also relates to a method of manufacturing a lithium ion battery cell that includes forming a slurry having a solvent, a conductive carbon, at least one binder, and a secondary LTO active material, wherein the secondary LTO active material includes secondary LTO particles having an average particle size (D₅₀) greater than 2 μm. The method includes depositing the slurry onto the surface of a metal to form the active layer of an anode and assembling the lithium ion battery cell using the anode.

The present disclosure further relates to a lithium ion battery cell that includes an electrode stack with a cathode having a cathode active layer and an anode having at least 5 milligrams (mg) of anode active layer per square centimeter (cm²) of anode. The anode active layer includes at least one polyvinylidene fluoride (PVDF) binder, a conductive carbon, and a secondary lithium titanate oxide (LTO), wherein the secondary LTO includes secondary LTO particles having an average particle size (D₅₀) greater than 2 μm.

### DRAWINGS

Various aspects of this disclosure may be better understood upon reading the following detailed description and upon reference to the drawings in which:

FIG. 1 is a perspective view of a vehicle having a battery module configured in accordance with present embodiments to provide power for various components of the vehicle;

FIG. 2 is a cutaway schematic view of the vehicle and the battery module of FIG. 1, in accordance with present embodiments;

FIG. 3 is a perspective view of an embodiment of a pouch battery cell, in accordance with embodiments of the present approach;

FIG. 4 is a scanning electron microscope (SEM) image of primary LTO particles, in accordance with embodiments of the present approach;

FIG. 5 is a top-down SEM image of a LTO anode surface made using the primary LTO particles of FIG. 4, in accordance with embodiments of the present approach;

FIG. 6 is a cross-sectional SEM image of the LTO anode of FIG. 3, in accordance with embodiments of the present approach;

FIGS. 7 and 8 are SEM images of secondary LTO particles at different magnifications, in accordance with embodiments of the present approach;

FIG. 9 is a top-down SEM image of a LTO anode surface made using the secondary LTO particles of FIGS. 7 and 8, in accordance with embodiments of the present approach;

FIG. 10 is a cross-sectional SEM image of the LTO anode active layer of FIG. 8, in accordance with embodiments of the present approach;

FIG. 11 is a carbon mapping image of the LTO anode of FIG. 6, in accordance with embodiments of the present approach;

FIG. 12 is a carbon mapping image of the LTO anode of FIG. 10, in accordance with embodiments of the present approach;

FIG. 13 is a graph illustrating charging rate data for LTO cells with different primary and secondary LTO materials, in accordance with embodiments of the present approach;

FIG. 14 is a graph illustrating discharging rate data for the battery cells represented in FIG. 13, in accordance with embodiments of the present approach;

FIG. 15 is a graph illustrating low temperature (−20° C.) performance for the battery cells represented in FIG. 13, in accordance with embodiments of the present approach;

FIG. 16 is a graph that summarizes the comparison of the different LTO active materials represented in FIGS. 13-15 in terms of processability, electrical performance, and cost, in accordance with embodiments of the present approach;

FIG. 17 is a graph illustrating area-specific impedance (ASI, Ohm·cm²) versus depth of discharge percentage (DOD %) during hybrid pulsed power characterization (HPPC) for a battery cell with primary LTO before and after 1 week at 60° C., in accordance with embodiments of the present approach;

FIG. 18 is a graph illustrating ASI versus DOD % during HPPC for a battery cell with secondary LTO before and after 1 week at 60° C., in accordance with embodiments of the present approach;

FIG. 19 is a graph illustrating the cell cycling performance at a 10C rate and 100% DOD for different LTO battery cells, in accordance with embodiments of the present approach;

FIG. 20 is a graph illustrating retention (%) and recovery (%) for battery cells with secondary LTO at 60° C., in accordance with embodiments of the present approach;

FIG. 21 illustrates the ASI of the battery cells represented in FIG. 20 before and after 1 month at 60° C., in accordance with embodiments of the present approach;

FIGS. 22 and 23 illustrate discharge rate data and charge rate data, respectively, for battery cells having secondary LTO particle materials with different compositions or loading, in accordance with embodiments of the present approach;

FIGS. 24A, 24B, and 24C include cathode and anode voltage curves for battery cells with secondary LTO wherein the negative-to-positive capacity ratio (N/P) is greater than 1, equal to 1, and less than 1, respectively, in accordance with embodiments of the present approach;

FIG. 25 illustrates cycle life data for the battery cells represented in FIGS. 24A, 24B, and 24C, in accordance with embodiments of the present approach;

FIG. 26 is a graph illustrating internal resistance at constant current (DC-IR) for battery cells with primary or secondary LTO particles having different anode loadings, in accordance with embodiments of the present approach; and

FIG. 27 is a flow diagram illustrating a process for manufacturing an anode using secondary LTO, in accordance with embodiments of the present approach.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The battery systems described herein may be used to provide power to various types of electric vehicles (xEVs) and other high voltage energy storage/expending applications (e.g., electrical grid power storage systems). Such battery systems may include one or more battery modules, each battery module having a number of battery cells (e.g., lithium ion (Li-ion) electrochemical cells) arranged to provide particular voltages and/or currents useful to power, for example, one or more components of an xEV.

As used herein, an “anode” refers to an electrode of a lithium ion battery cell that includes an active layer disposed on a surface of a metal layer (e.g., an aluminum strip or plate). As used herein, an “anode active layer” or an “active layer of an anode” refers to a film that is deposited on the surface of the metal layer to facilitate the electrochemistry of the lithium ion battery cell, wherein the anode active layer includes an LTO anode active material. As used herein, “anode loading” or “loading of an anode” refers to the weight (e.g., in milligrams) of the active layer per unit area (e.g., in cm²) of a surface (e.g., a side) of the anode, understanding that the active layer is generally deposited onto each side of the anode at the described level of loading. As used herein, “anode active material” or “active material of an anode” refers to a lithium titanate oxide (LTO) material that is part of the active layer of an anode of a lithium ion battery. As used herein, a “stack” or an “electrode stack” refers to a multi-layered structure within the battery cell that includes a number of alternating cathode and anode layers (with separating layers disposed between) that stores electrical energy within the battery cell. For example, the stack of the battery cell may be implemented in the form of a stack of cathode and anode plates, or in the form of a “jelly-roll” having continuous cathode and anode strips that are aligned and rolled together about a common axis (e.g., using a mandrel) to yield a multi-layered structure. As used herein, “average particle size” refers to D₅₀ in terms of particle size distribution (PSD) nomenclature, which is the average particle diameter by mass. Charge and discharge rates may be described herein in terms of C-rates (i.e., 1 C, 5 C, 10 C), wherein the number indicates the amount of charge (in coulombs) per second passing into or out of the battery cell.

Lithium titanate oxide (LTO) offers many advantages as an anode active material for lithium ion battery cells. For example, LTO-based lithium ion batteries generally demonstrate excellent charge acceptance, superior performance at low temperature, and good cycle life. Further, due the relatively high voltage of LTO (e.g., approximately 1.55 V relative to lithium metal), LTO lacks lithium plating issues experienced by other anode active materials during the charge process. However, it is presently recognized that LTO suffers from poor processability, which contributes difficulty, time, and cost to the manufacture of the anode and the battery cell. Further, it is also presently recognized that, at least in part due to this poor processability, the electrical properties of LTO-based lithium ion battery cells suffers when the loading of the anode is relatively high (e.g., greater than 5 mg/cm²).

With the forgoing in mind, present embodiments are directed toward LTO anode active materials, as well as electrode and battery cell designs, that enable the manufacture of lithium ion battery cells having excellent discharge power and charge power (e.g., up to 8800 Watts per liter (W/L)), and are suitable for use with xEVs, such as the micro-hybrid xEVs mentioned above. To address the aforementioned processability problems of LTO, present embodiments involve the use of secondary LTO particulate materials to enable the practical manufacture of LTO anodes having relatively high loading (e.g., greater than approximately 5 mg/cm²), which enables the manufacture of LTO batteries with secondary LTO particles that have improved electrical properties (e.g., higher energy and higher power density) compared to LTO battery cells made using primary LTO particles. As set forth below, compared to LTO cell with primary particles, LTO cells with secondary LTO particles can have significantly higher anode loading without significant performance losses. Additionally, in certain embodiments, the disclosed LTO anodes with secondary LTO particles enable the production of LTO battery cells having lower impedance, better high temperature performance, and improved calendar life when compared to LTO cells with primary particles.

As used herein, LTO refers to any lithium titanium-based oxide (e.g., Li₄Ti₅O₁₂) having a spinel structure. As such, an LTO material generally includes lithium, titanium, and oxygen, and, in certain embodiments, may include other dopant atoms as well. As used herein, “primary LTO” refers to a LTO material that comprises single grains (e.g., individual crystals) of LTO. The average particle size of the primary LTO particles in a primary LTO is less than approximately 2 μm (e.g., between approximately 1 μm and approximately 1.5 μm). In contrast, as used herein, “secondary LTO” refers to a LTO material that comprises secondary LTO particles, which may be formed by agglomerating (e.g., sintering) primary LTO particles into larger particles having a secondary (e.g., spherical) morphology. As such, the average particle size of the secondary LTO particles in a secondary LTO is greater than approximately 2 μm (e.g., between approximately 2 μm and 20 μm). Additionally, 99% or more of the secondary LTO particles of a secondary LTO, as used herein, have a diameter less than 60 μm. Since a secondary LTO is formed via the agglomeration of a primary LTO, a secondary LTO may be described herein according to the size of the secondary LTO particles (e.g., D₅₀ of the secondary LTO particles), according to the size of the primary LTO particles used to form the secondary LTO particles (e.g., D₅₀ of the primary LTO particles before agglomeration), or combinations thereof.

It may be appreciated that the electrical performance enabled by the disclosed secondary LTO active materials, as discussed below, is believed to be unexpected considering other methods for manufacturing LTO anodes teach against using having agglomerates or aggregates of primary LTO particles present in the anode active layer, as this has been previously observed to decrease electrical performance of the resulting battery cell. However, herein we disclose a number of secondary LTO materials made of agglomerated primary LTO particles having dimensions (e.g., primary and secondary particle sizes) and morphologies (e.g., secondary morphologies) that enable the disclosed advantages over certain primary LTO active materials in terms of processability, electrical performance, design freedom, and/or cost.

### Battery Module

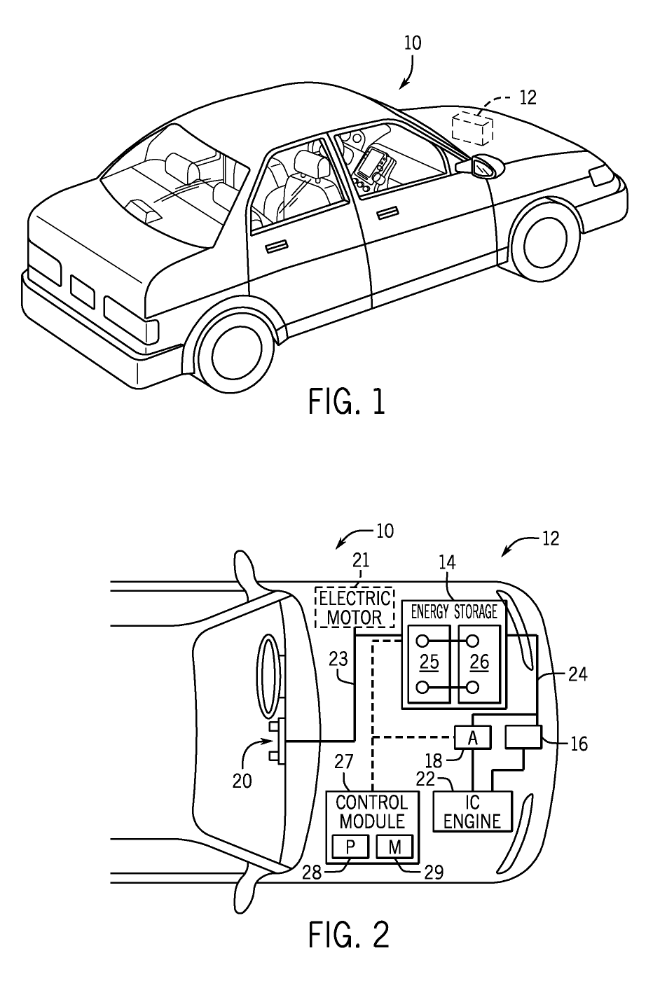

With the foregoing in mind, present embodiments relating to secondary LTO materials, anode designs, and battery cell designs may be applied in any number of energy expending systems (e.g., vehicular contexts and stationary power contexts). To facilitate discussion, embodiments of the battery modules described herein are presented in the context of advanced battery modules (e.g., lithium ion battery modules) employed in xEVs. To help illustrate, FIG. 1 is a perspective view of an embodiment of a vehicle 10, which may utilize a regenerative braking system. Although the following discussion is presented in relation to vehicles with regenerative braking systems, the techniques described herein are adaptable to other vehicles that capture/store electrical energy with a battery, which may include electric-powered and gas-powered vehicles.

As discussed above, it would be desirable for a battery system 12 to be largely compatible with traditional vehicle designs. Accordingly, the battery system 12 may be placed in a location in the vehicle 10 that would have housed a traditional battery system. For example, as illustrated, the vehicle 10 may include the battery system 12 positioned similarly to a lead-acid battery of a typical combustion-engine vehicle (e.g., under the hood of the vehicle 10). Furthermore, as will be described in more detail below, the battery system 12 may be positioned to facilitate managing temperature of the battery system 12. For example, in some embodiments, positioning a battery system 12 under the hood of the vehicle 10 may enable an air duct to channel airflow over the battery system 12 and cool the battery system 12.

A more detailed view of the battery system 12 is described in FIG. 2. As depicted, the battery system 12 includes an energy storage component 14 coupled to an ignition system 16, an alternator 18, a vehicle console 20, and optionally to an electric motor 21. Generally, the energy storage component 14 may capture/store electrical energy generated in the vehicle 10 and output electrical energy to power electrical devices in the vehicle 10.

In other words, the battery system 12 may supply power to components of the vehicle's electrical system, which may include radiator cooling fans, climate control systems, electric power steering systems, active suspension systems, auto park systems, electric oil pumps, electric super/turbochargers, electric water pumps, heated windscreen/defrosters, window lift motors, vanity lights, tire pressure monitoring systems, sunroof motor controls, power seats, alarm systems, infotainment systems, navigation features, lane departure warning systems, electric parking brakes, external lights, or any combination thereof Illustratively, in the depicted embodiment, the energy storage component 14 supplies power to the vehicle console 20 and the ignition system 16, which may be used to start (e.g., crank) the internal combustion engine 22.

Additionally, the energy storage component 14 may capture electrical energy generated by the alternator 18 and/or the electric motor 21. In some embodiments, the alternator 18 may generate electrical energy while the internal combustion engine 22 is running More specifically, the alternator 18 may convert the mechanical energy produced by the rotation of the internal combustion engine 22 into electrical energy. Additionally or alternatively, when the vehicle 10 includes an electric motor 21, the electric motor 21 may generate electrical energy by converting mechanical energy produced by the movement of the vehicle 10 (e.g., rotation of the wheels) into electrical energy. Thus, in some embodiments, the energy storage component 14 may capture electrical energy generated by the alternator 18 and/or the electric motor 21 during regenerative braking. As such, the alternator and/or the electric motor 21 are generally referred to herein as a regenerative braking system.

To facilitate capturing and supplying electric energy, the energy storage component 14 may be electrically coupled to the vehicle's electric system via a bus 24. For example, the bus 24 may enable the energy storage component 14 to receive electrical energy generated by the alternator 18 and/or the electric motor 21. Additionally, the bus may enable the energy storage component 14 to output electrical energy to the ignition system 16 and/or the vehicle console 20. Accordingly, when a 12 volt battery system 12 is used, the bus 24 may carry electrical power typically between 8-18 volts.

Additionally, as depicted, the energy storage component 14 may include multiple battery modules. For example, in the depicted embodiment, the energy storage component 14 includes a lithium ion (e.g., a first) battery module 25 and a lead-acid (e.g., a second) battery module 26, which each includes one or more battery cells. In other embodiments, the energy storage component 14 may include any number of battery modules. Additionally, although the lithium ion battery module 25 and lead-acid battery module 26 are depicted adjacent to one another, they may be positioned in different areas around the vehicle. For example, the lead-acid battery module 26 may be positioned in or about the interior of the vehicle 10 while the lithium ion battery module 25 may be positioned under the hood of the vehicle 10.

In some embodiments, the energy storage component 14 may include multiple battery modules to utilize multiple different battery chemistries. For example, when the lithium ion battery module 25 is used, performance of the battery system 12 may be improved since the lithium ion battery chemistry generally has a higher coulombic efficiency and/or a higher power charge acceptance rate (e.g., higher maximum charge current or charge voltage) than the lead-acid battery chemistry. As such, the capture, storage, and/or distribution efficiency of the battery system 12 may be improved.

To facilitate controlling the capturing and storing of electrical energy, the battery system 12 may additionally include a control module 27. More specifically, the control module 27 may control operations of components in the battery system 12, such as relays (e.g., switches) within energy storage component 14, the alternator 18, and/or the electric motor 21. For example, the control module 27 may regulate amount of electrical energy captured/supplied by each battery module 25 or 26 (e.g., to de-rate and re-rate the battery system 12), perform load balancing between the battery modules 25 and 26, determine a state of charge of each battery module 25 or 26, determine temperature of each battery module 25 or 26, control voltage output by the alternator 18 and/or the electric motor 21, and the like.

Accordingly, the control module 27 may include one or processor 28 and one or more memory 29. More specifically, the one or more processor 28 may include one or more application specific integrated circuits (ASICs), one or more field programmable gate arrays (FPGAs), one or more general purpose processors, or any combination thereof. Additionally, the one or more memory 29 may include volatile memory, such as random access memory (RAM), and/or non-volatile memory, such as read-only memory (ROM), optical drives, hard disc drives, or solid-state drives. In some embodiments, the control module 27 may include portions of a vehicle control unit (VCU) and/or a separate battery control module. Furthermore, as depicted, the lithium ion battery module 25 and the lead-acid battery module 26 are connected in parallel across their terminals. In other words, the lithium ion battery module 25 and the lead-acid module 26 may be coupled in parallel to the vehicle's electrical system via the bus 24.

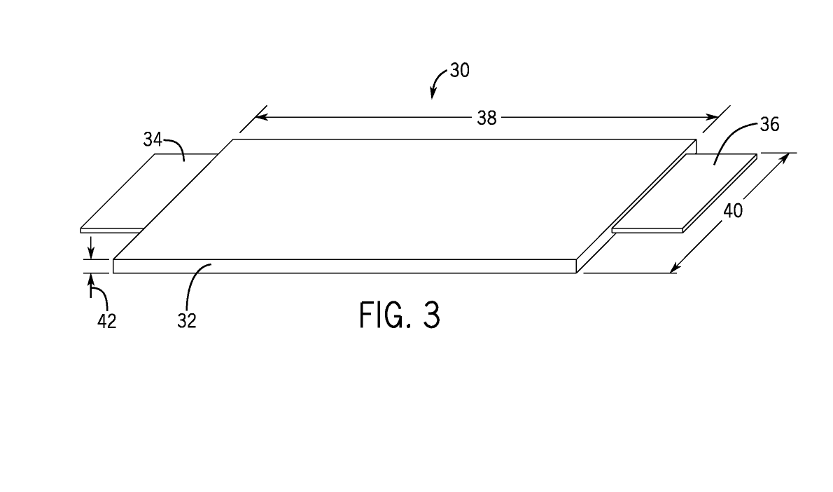

The lithium ion battery modules 25 described herein, as noted, may include a number of lithium ion electrochemical battery cells electrically coupled to provide particular currents and/or voltages to provide power to the xEV 10. FIG. 3 is a perspective view of an embodiment of a pouch battery cell 30, in accordance with embodiments of the present approach. While FIG. 3 illustrates a pouch battery cell 30 as an example, in other embodiments, other battery cell shapes (e.g., cylindrical, rectangular prismatic) may be used. The illustrated pouch battery cell 30 has a polymer packaging 32 that encloses the internal components of the cell, including the electrode stack and electrolyte. In certain embodiments, the battery cell 30 may be any lithium ion electrochemical cell that utilizes lithium titanate oxide (LTO) as an anode active material, such as lithium nickel manganese cobalt oxide (NMC)/LTO battery cells. As used herein, NMC battery cells have a cathode active material that includes lithium, nickel, manganese, and cobalt (e.g., LiₓNiₐMn_{b}Co_{c}O₂, wherein x+a+b+c=2) in a layered structure. The illustrated pouch battery cell 30 includes a positive terminal 34 and a negative terminal 36 that extend from opposite ends of the battery cell 30. Further, the positive terminal 34 is electrically coupled to the cathode layers, and the negative terminal 36 is electrically coupled to the anode layers, of the stack disposed within the packaging 32 the battery cell 30.

As discussed below, in certain embodiments, the battery cell 30 may be designed to have a particular set of dimensions that enable a particular power density to be achieved. The pouch battery cell 30 of FIG. 3 may be described as having a particular length 38, width 40, and thickness 42. As such, the volume of the battery cell 30, which is used to calculate power density of the battery cell 30, is the product of these three values. For example, in certain embodiments discussed below, the battery cell 30 may have a length 38 of approximately 234 mm, a width 40 of approximately 130 mm, and a thickness 42 of approximately 5.3 mm to provide a volume of approximately 0.16 liters (L). As discussed below, in addition to the volume of the battery cell 30, other parameters of the battery cell 30 (e.g., anode loading or number of anode layers in the stack) may be selected to yield a battery cell 30 having a particular power density.

### Secondary LTO Materials

TABLE 1
Nine different LTO materials used as the anode active material for
embodiments of the present approach.

| | | | | | | BET |
|---|---|---|---|---|---|---|
| | | Particle Size Distribution (PSD) | | | | Surface |
| | | (μm) | | | | Area |
| Name | Type | D₁₀ | D₅₀ | D₉₀ | D₁₀₀ | m²/g |
| LTO1 | Secondary | 0.62 | 3.34 | 12.45 | 39.81 | 6.822 ± 0.0416 |
| LTO1-1 | Secondary | 5.06 | 11.32 | 31.91 | 75 | 2.4634 ± 0.0064 |
| LTO2 | Secondary | 6.34 | 15.01 | 33.39 | 60 | 13.140 ± 0.0208 |
| LTO3 | Primary | 0.52 | 1.1 | 3.76 | 10 | 9.383 ± 0.0395 |
| LTO4 | Primary | 0.53 | 1.16 | 2.95 | 10.59 | 5.056 ± 0.0154 |
| LTO5 | Secondary | 1.99 | 5.56 | 12.56 | 29.85 | 2.881 ± 0.015 |
| LTO6 | Secondary | 8.17 | 16.83 | 29.36 | 47.32 | 2.853 ± 0.0294 |
| LTO7 | Secondary | 2.23 | 6.3 | 15.32 | 42.17 | 3.646 ± 0.0136 |
| LTO7-1 | Secondary | 2.05 | 5 | 9.94 | 23.71 | 3.851 ± 0.011 |

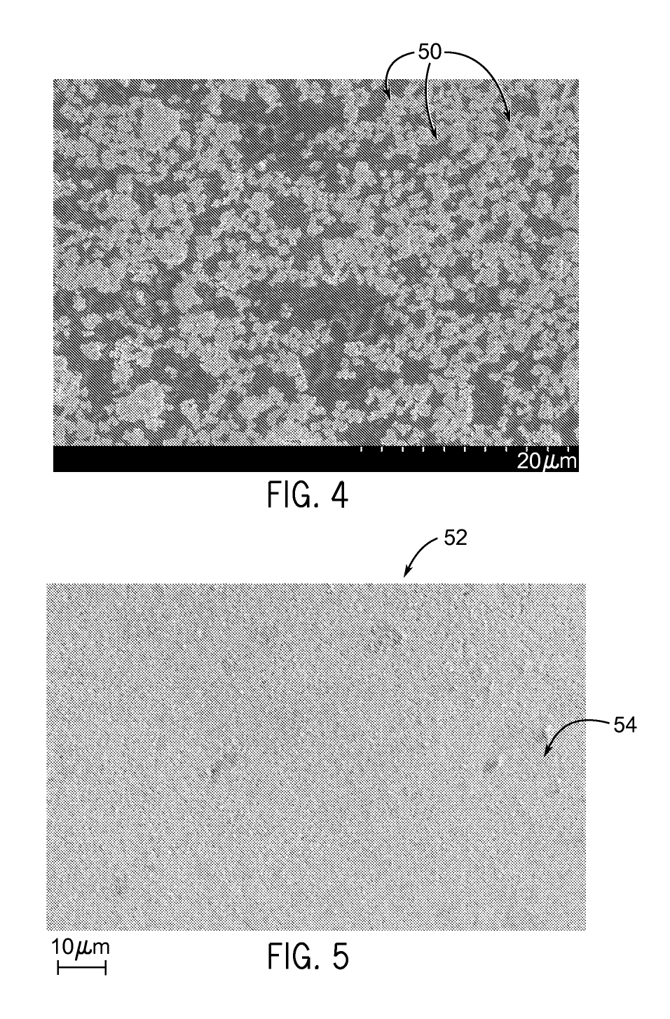

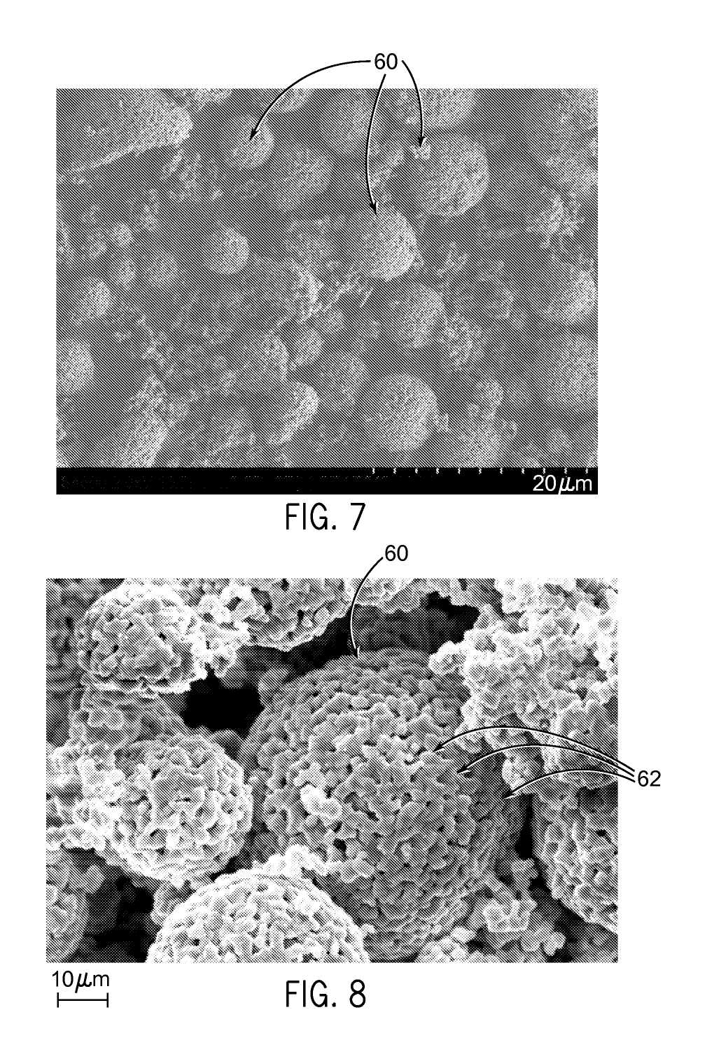

As mentioned above, present embodiments utilize a secondary LTO as an anode active material. Nine different LTO materials are presented in Table 1. More specifically, Table 1 indicates the type (i.e., primary or secondary LTO), particle size distribution (PSD) data, and Brunauer-Emmett-Teller (BET) surface area analysis data for each of these LTO materials. Additionally, FIGS. 4-6 include an SEM image of an example primary LTO (i.e., LTO4), as well as SEM images of an anode active layer made using this primary LTO. For comparison, FIGS. 7-10 include SEM images of an example secondary LTO (i.e., LTO7), as well as SEM images of an anode active layer made using this secondary LTO.

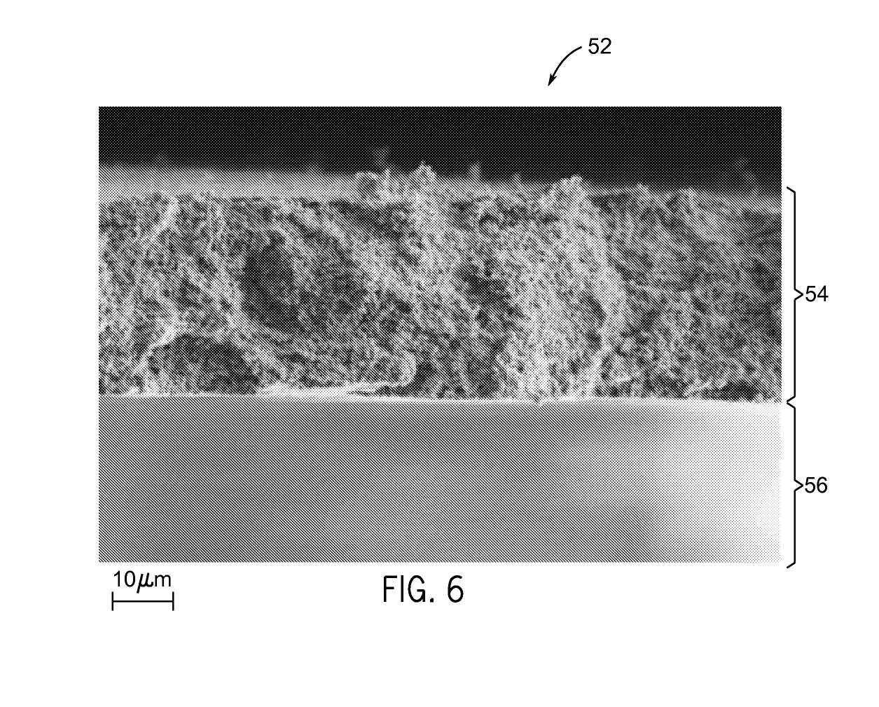

In particular, the SEM image of FIG. 4 illustrates primary LTO particles 50 having an average particle size of approximately 1 μm. FIG. 5 illustrates a top-down view of a LTO anode 52 having an active layer 54 made using the primary LTO particles 50 illustrated in FIG. 4. FIG. 6 illustrates a cross-sectional view of the LTO anode 52 illustrated in FIG. 4, in which both the active layer 54 and the metal layer 56 of the LTO anode 52 may be seen. As illustrated in FIGS. 5 and 6, the primary LTO particles 50 are tightly packed and form the relatively low porosity active layer 54 of the LTO anode 52. It may be appreciated that the small size (e.g., approximately 1 μm) of the primary LTO particles 50, as illustrated in FIG. 4, also results in the aforementioned processability issues during mixing and deposition when manufacturing the anode 52, as discussed further below.

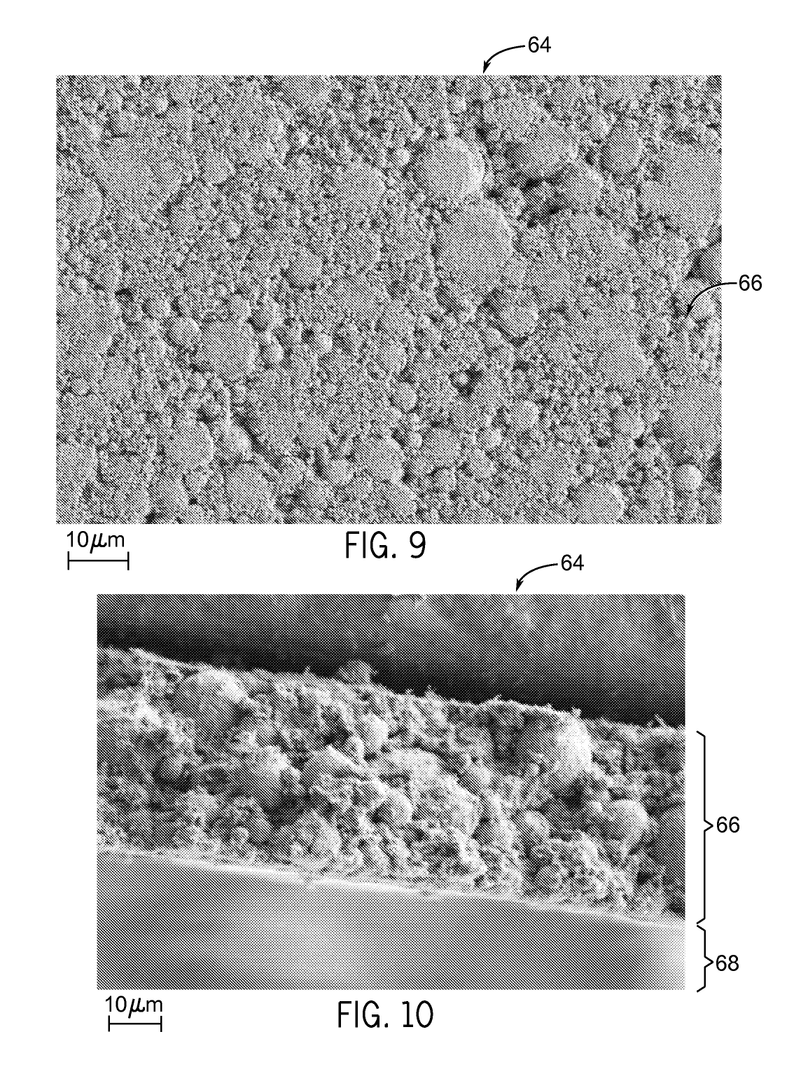

As illustrated in the SEM images of FIGS. 7 and 8, the example secondary LTO particles 60 generally have a spherical shape or secondary morphology. The illustrated secondary LTO particles 60 have an average particle size of approximately 6.3 μm. Additionally, these secondary LTO particles 60 are agglomerations of substantially smaller primary LTO particles 62, and the smaller primary LTO particles 62 have an average particle size of approximately 100 nm. FIG. 9 illustrates a top-down view of an anode 64 having an active layer 66 made from the secondary LTO particles 60 illustrated in FIGS. 7 and 8. FIG. 10 illustrates a cross-sectional view of the anode active layer 64 of FIG. 9 in which both the active layer 66 and the metal layer 68 of the LTO anode 64 may be seen. As illustrated in FIGS. 9 and 10, secondary LTO enables the production of an anode active layer 66 that is substantially more porous than the LTO active layer 54 of the anode 52 illustrated in FIGS. 5 and 6. This enhanced porosity enables the production of anodes 64 that have improved electrical performance, as discussed below, and enables the fabrication of anodes 64 having thicker active layers 66 (i.e., anodes with higher loading).

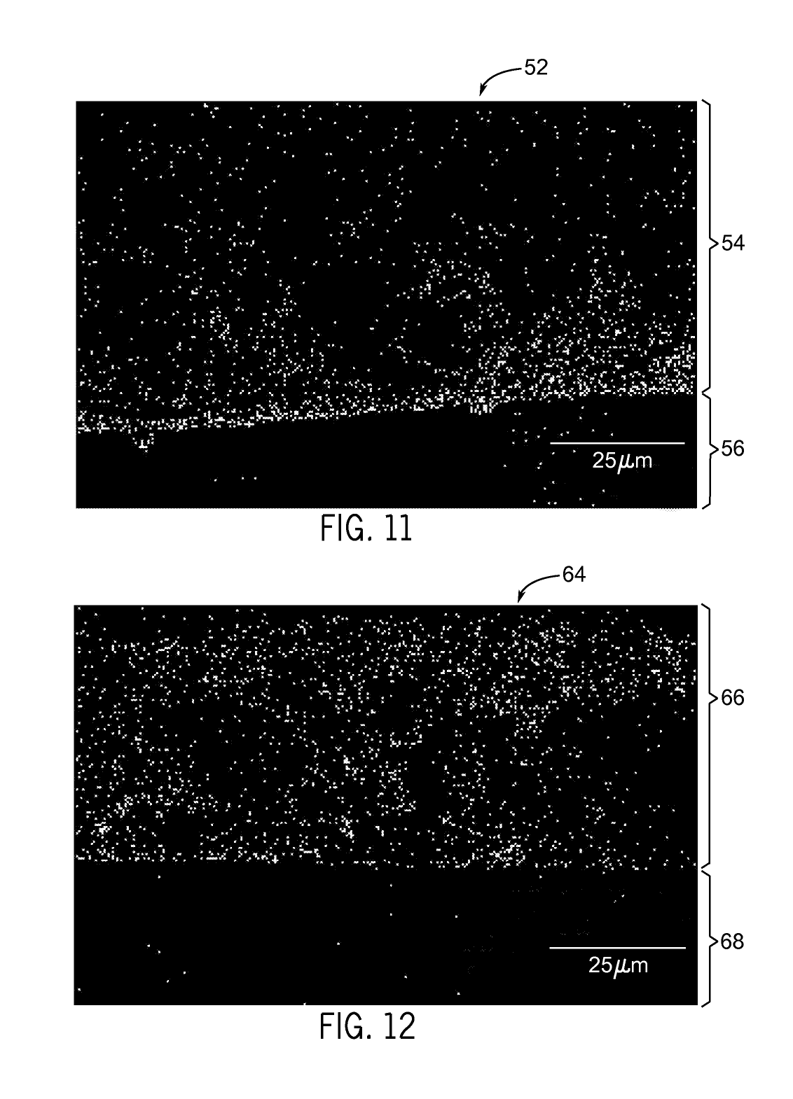

To further illustrate differences between the LTO anode 52 made using primary LTO and the LTO anode 64 made using secondary LTO, FIG. 11 illustrates carbon mapping data for the LTO anode 52, as illustrated in FIG. 6. For comparison, FIG. 12 illustrates carbon mapping data for the LTO anode 64, as illustrated in FIG. 10. In the carbon mapping data of FIGS. 11 and 12, the white pixels represent the presence of one or more carbon atoms within the active layers 54 and 66. As such, the carbon mapping data of FIG. 12 demonstrates better carbon dispersion within the LTO active layer 66 compared to the LTO active layer 54 of FIG. 11. The improved carbon dispersion of the LTO anode 64 is a result of the improved processability of the secondary LTO during the mixing and deposition processes used to form the anode 64, as discussed below.

With the foregoing in mind, it is presently recognized that the morphology of the secondary LTO substantially affects the processability of the secondary LTO during anode manufacturing, as well as the eventual electrical performance of LTO battery cell. For example, it is presently recognized that, when the secondary LTO has a medium secondary particle size and a small primary particle size, the electrical performance and the processability of the secondary LTO are substantially better. By specific example, for a secondary LTO, when the average particle size of the secondary LTO particles is less than 12 μm (e.g., less than 10 μm, or approximately 6 μm) and the average particle size of the primary LTO particles (i.e., the average particle size of the agglomerated primary LTO particle grains within the secondary LTO particles) is less than 500 nm (e.g., less than 250 nm, or approximately 100 nm), excellent processability and electrical performance may be achieved. For example, the secondary LTO illustrated in FIGS. 7-10 (i.e., LTO7) falls within these secondary and primary particle size ranges and, as set forth below, enables advantages in terms of both processability and resulting electrical performance compared to other LTO materials.

### Electrical Characteristics of Secondary LTO Materials

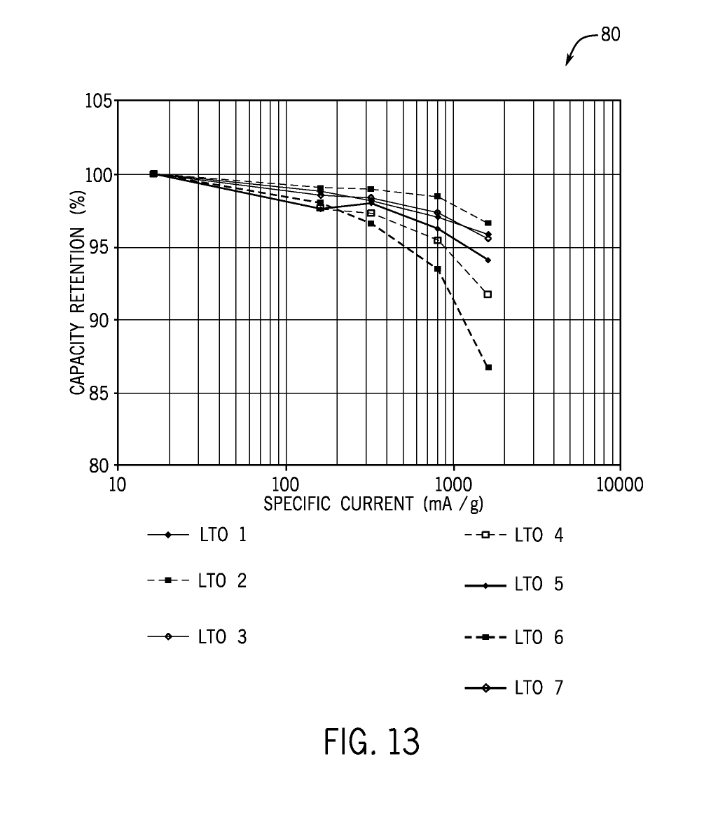

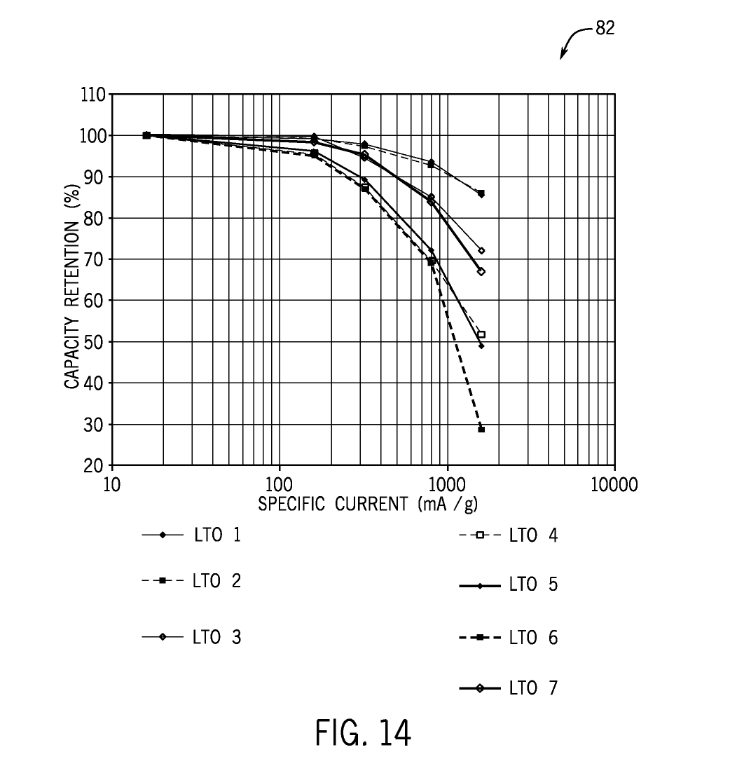

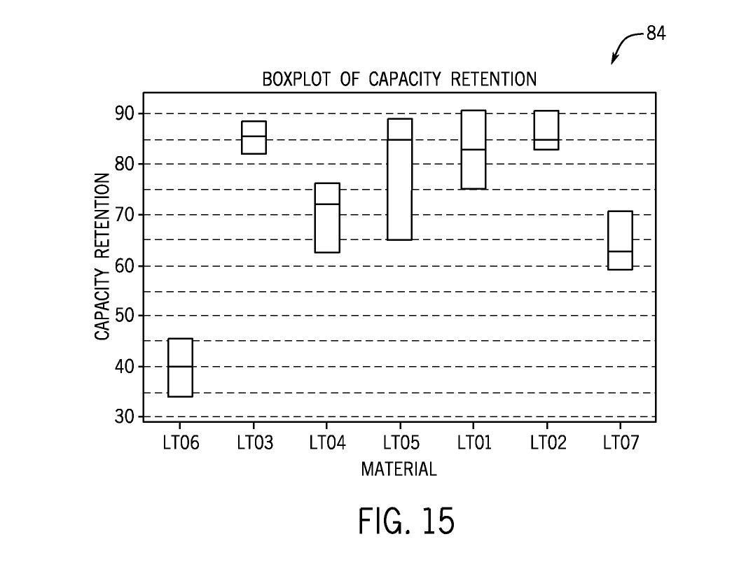

Coin battery cells were produced using a number of different secondary LTO materials (i.e., LTO1, LTO2, LTO5, LTO6, and LTO7) as well as different primary LTO materials (i.e., LTO3 and LTO4), and the coin battery cells were subsequently electrically evaluated for comparison. A representative portion of the electrical performance data for different LTO active materials is illustrated in FIGS. 13-15. Namely, the graph 80 of FIG. 13 illustrates charging rate data, the graph 82 of FIG. 14 illustrates discharging rate data, and the graph 84 of FIG. 15 illustrates low temperature (−20° C.) capacity retention (%) for embodiments of LTO battery cells made using the indicated primary or secondary LTO material. As illustrated by FIGS. 13-15, a number of secondary LTO materials perform as well as (or better than) the represented primary LTO materials. In particular, LTO7 demonstrates excellent discharge and regeneration power performance and low temperature performance.

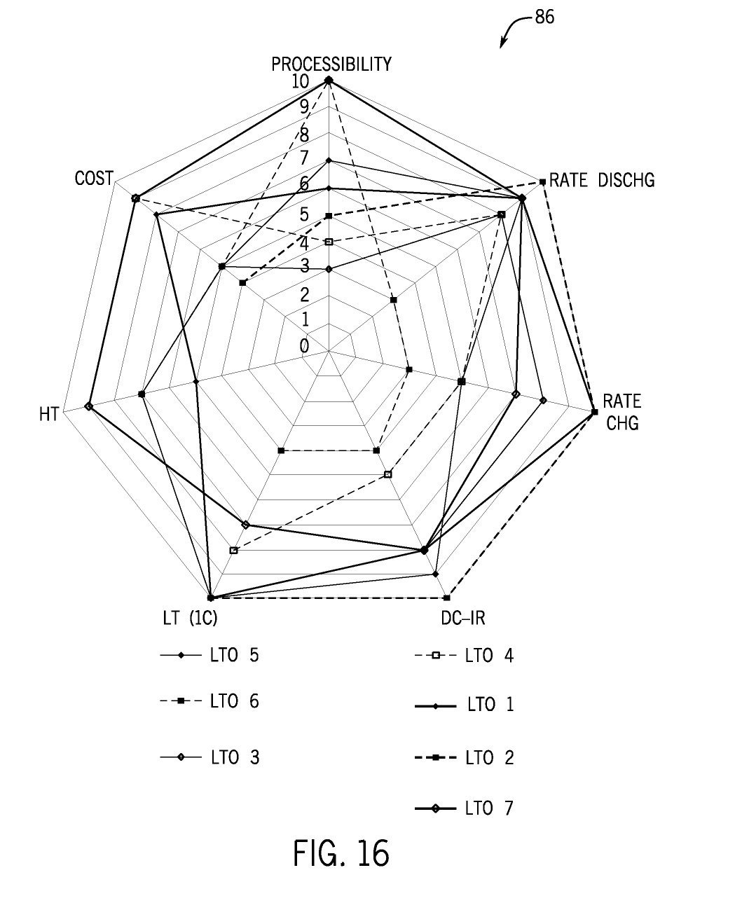

FIG. 16 summarizes the comparison of the LTO active materials represented in FIGS. 13-15 in terms of processability, electrical performance, and cost. In particular, the graph 86 of FIG. 16 breaks the comparison of the LTO active materials into terms of: processability, discharging rate, charging rate, direct current impedance (DC-IR), low temperature performance (LT, −20° C. at 1C rate) high temperature performance (HT, 60° C.), and cost associated with each the various LTO materials, each rated on a scale from 1 to 10. It is presently recognized, based on the comparison data presented in the graph 86 of FIG. 16, that certain secondary LTO active materials (e.g., LTO7) enable substantial advantages over certain primary LTO active materials in terms of processability, electrical performance, and/or cost.

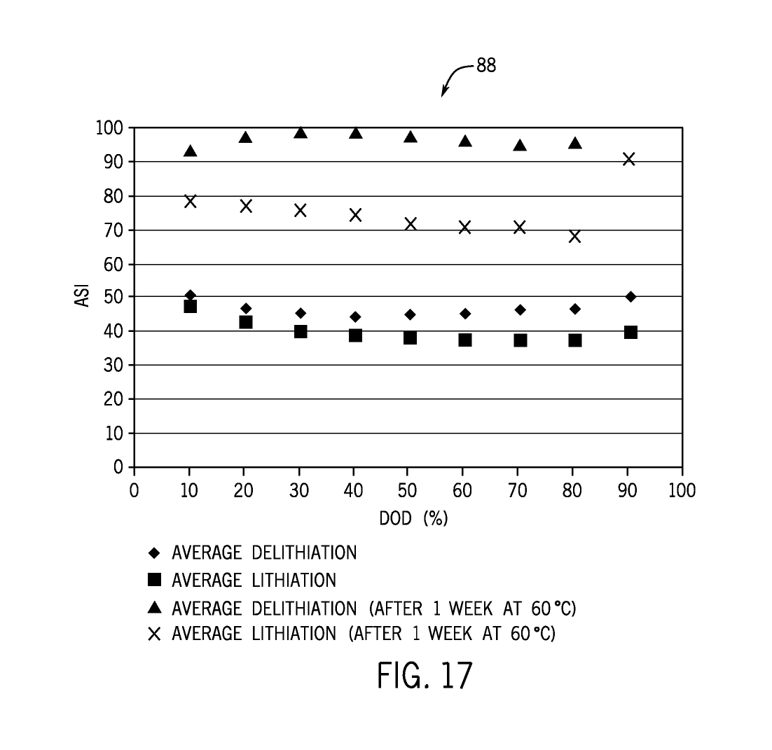

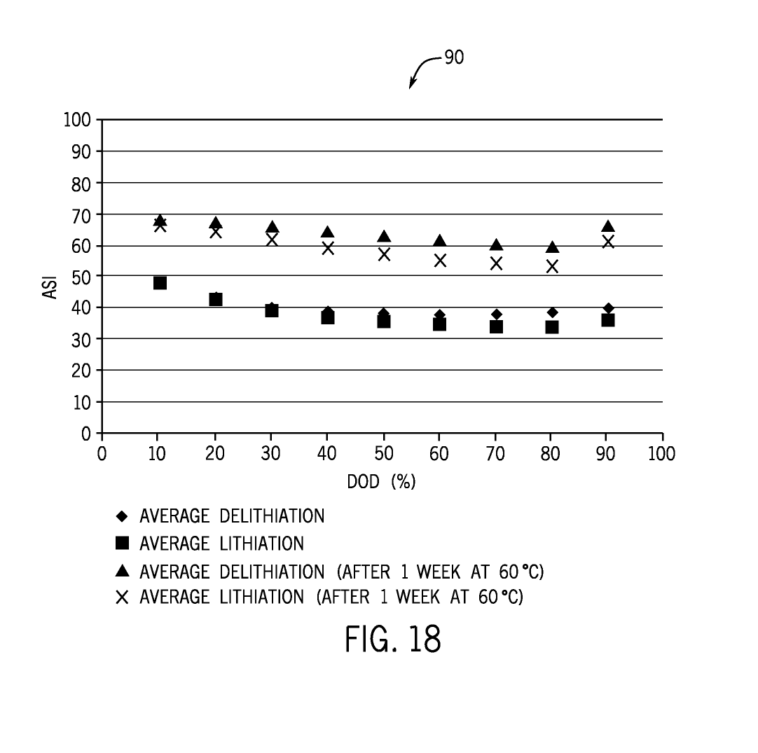

FIG. 17 is a graph 88 illustrating area-specific impedance (ASI in Ohm·cm²) versus depth of discharge percentage (DOD %) during hybrid pulsed power characterization (HPPC) of a LTO half-coin battery cell made using a primary LTO (i.e., LTO4). For comparison, FIG. 18 is a graph 90 illustrating ASI versus DOD % during HPPC of a LTO half-coin battery cell made using a secondary LTO (i.e., LTO7). As illustrated by the graphs 88 and 90, the both cells experience an increase in ASI after 1 week at 60° C. For example, after 1 week at 60° C., the LTO battery cell represented in the graph 88 of FIG. 17 demonstrates a maximum ASI of approximately 100 Ohm·cm², while the LTO battery cell represented in the graph 90 of FIG. 18 demonstrates a maximum ASI of approximately 70 Ohm·cm². Further, the increase in ASI is substantially less (e.g., less than 50% increase) for the battery cell with secondary LTO after 1 week at 60° C., as illustrated by the graph 90 of FIG. 18. By comparison, the increase in ASI is substantially greater (e.g., greater than 100% increase) for the battery cell with the primary LTO after 1 week at 60° C., as illustrated by the graph 88 of FIG. 17.

Furthermore, as illustrated by the graph 88 of FIG. 17, the delithiation component of the ASI of the battery cell with the primary LTO is substantially higher after 1 week at 60° C., and this increase is not observed for the battery cell with secondary LTO represented in the graph 90 of FIG. 18. That is, the average lithiation component and the average delithiation component of the ASI of the battery cell with secondary LTO both increase by approximately 50% or less after 1 week at 60° C., compared to the increase of approximately 100% or more for the battery cell with primary LTO. Accordingly, based on the reduced rate of ASI increase illustrated in FIGS. 17 and 18, it is presently recognized that certain secondary LTO active materials (e.g., LTO7) enable the manufacture of battery cells having improved calendar life performance compared to certain battery cells with primary LTO.

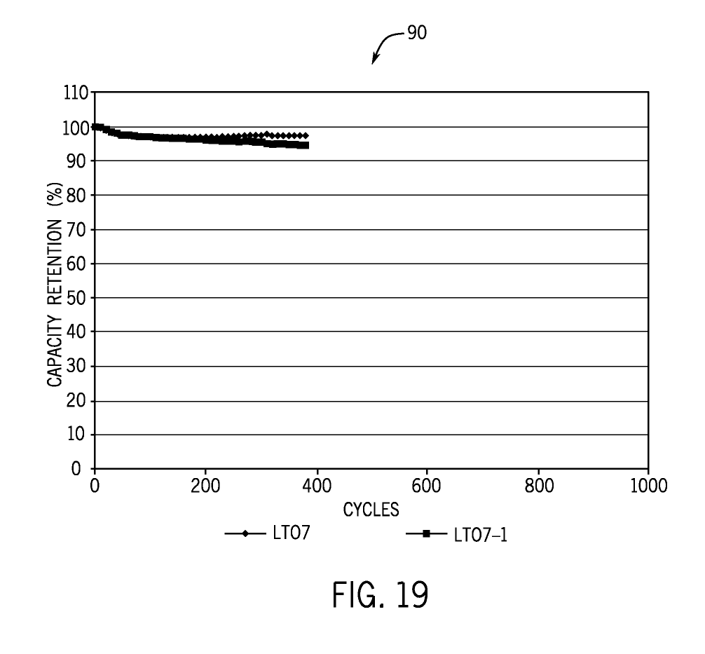

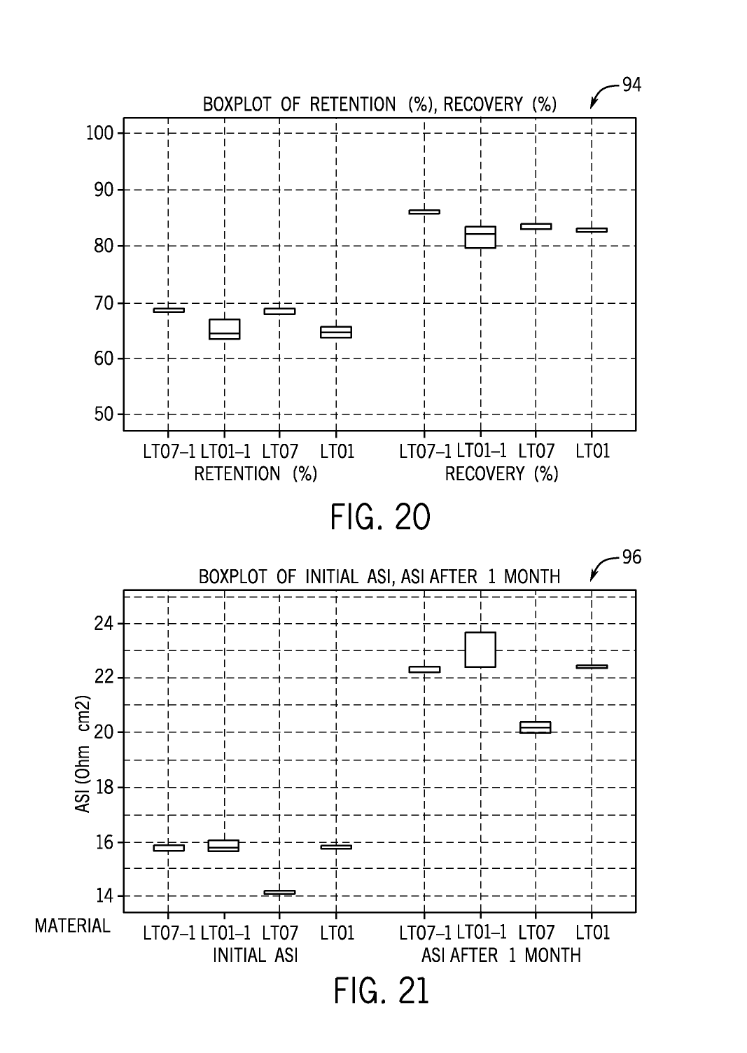

The graph 92 of FIG. 19 illustrates the cell cycling performance at a rapid charge/discharge rate (i.e., 10C with 100% DOD) for embodiments of battery cells made using secondary LTO (i.e., either LTO7 or LTO7-1, as indicated). For example, the represented battery cell embodiments demonstrate excellent capacity retention (e.g., greater than 90%, greater than 95%) after the 400 cycles at 10 C. As such, the represented battery cell embodiments demonstrate only a small capacity retention decrease (e.g., less than 10%, less than 5%) after the 400 cycles at 10 C. As such, based on the cycling data presented in the graph 92 of FIG. 20, it is presently recognized that certain secondary LTO active materials (e.g., LTO7, LTO7-1) enable excellent capacity retention during successive, rapid charge/discharge cycles (e.g., 400 cycles at 10 C).

The graph 94 of FIG. 20 illustrates retention (%) and recovery (%) for different embodiments of coin battery cells operating at 60° C. for 1 month, in which the battery cells each include the indicated secondary LTO active material (i.e., LTO7, LTO7-1, LTO1, or LTO1-1). The represented LTO battery cell embodiments demonstrate good capacity retention (e.g., greater than approximately 60% or 65%) when operating at 60° C. The represented LTO battery cell embodiments also demonstrate good recovery (e.g., greater than approximately 80% or 85%) when operating at 60° C. As such, based on the retention/recovery data presented in the graph 94 of FIG. 20, it is presently recognized that certain secondary LTO active materials (e.g., LTO7) enable excellent capacity retention during high temperature operation (e.g., after 1 month at 60° C.).

The graph 96 of FIG. 21 illustrates the ASI for the battery cell embodiments represented in FIG. 20 both before and after 1 month at 60° C. The represented embodiments demonstrate a low initial ASI (e.g., less than 15 Ohm·cm², less than 14 Ohm·cm²) and relatively low ASI after 1 month at 60° C. (e.g., less than 24 Ohm·cm², less than 21 Ohm·cm²). Further, the ASI increase is relatively small (e.g., less than 50%, less than 45%) after 1 month at 60° C. As such, based on the ASI data presented in the graph 96 of FIG. 21, it is presently recognized that certain secondary LTO active materials (e.g., LTO7) enable a low initial ASI and a slow rate of ASI increase after 1 month at 60° C., indicating good high-temperature performance and calendar life.

### LTO Anode Design

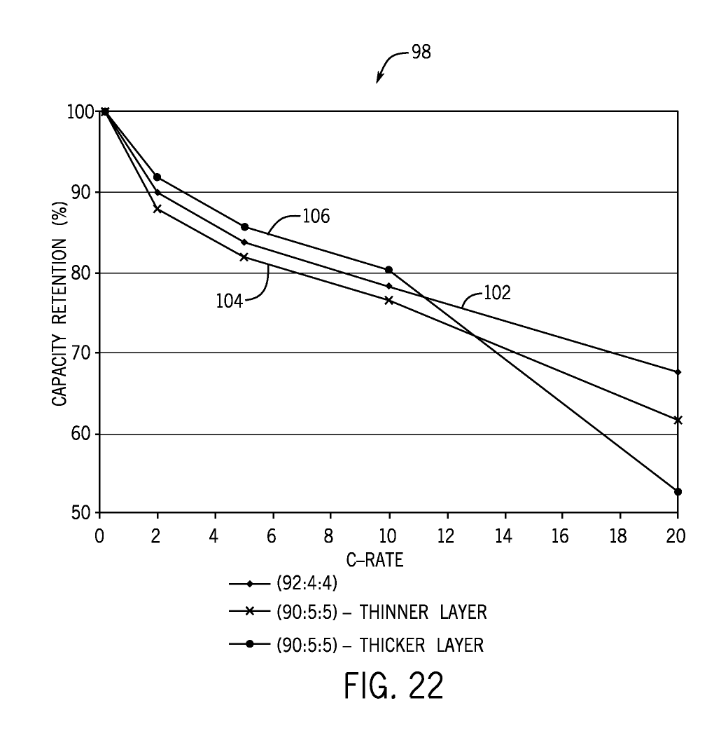

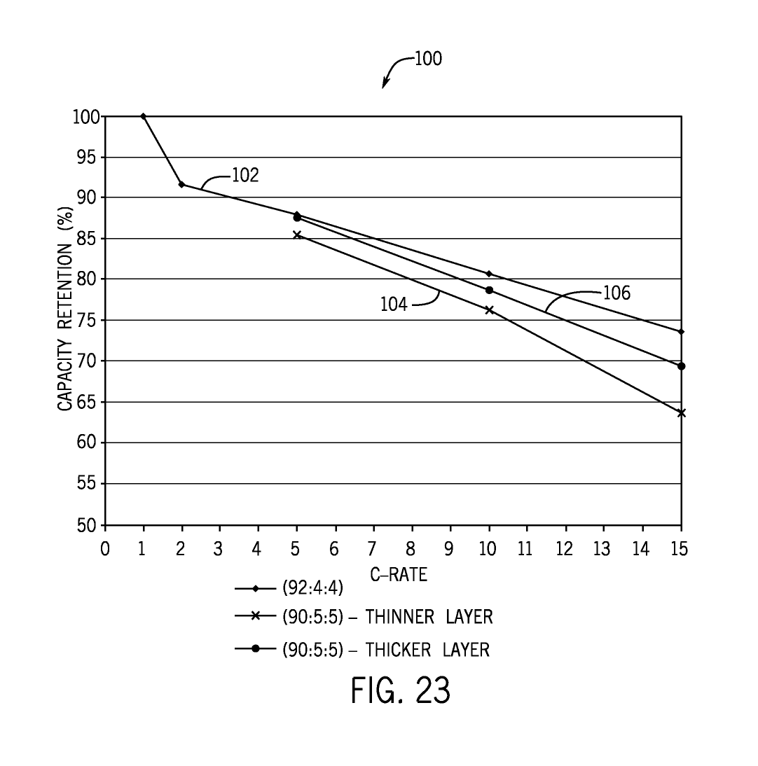

It is also presently recognized that the relative ratio of components in the active layer 66 of the disclosed anodes 64 also affect the electrical performance of the resulting battery cell 30. For example, the graphs 98 and 100 of FIGS. 22 and 23 illustrate discharge rate data and charge rate data, respectively, for embodiments of battery cells having anodes 64 with different active layers 66 made using a particular secondary LTO (i.e., LTO7), a conductive carbon (i.e., carbon black) and a binder (i.e., one or more polyvinylidene fluoride (PVDF) binders), at particular relative ratios. For example, the embodiment of the LTO battery cell 102 represented in FIGS. 22 and 23 has an anode active layer 66 that includes: 92 wt % secondary LTO, 4 wt % conductive carbon, and 4 wt % binder. The LTO battery cells 104 and 106 represented in FIGS. 22 and 23 both have anode active layers 66 that include: 90 wt % secondary LTO, 5 wt % conductive carbon, and 5 wt % binder. However, the battery cell 106 has higher anode loading (e.g., 7.5 mg/cm²) and, therefore, a thicker active layer 66. As illustrated in FIG. 22, battery cell 102 demonstrates better capacity retention during discharge, especially at discharge rates of C10 or less, compared battery cells 104 and 106. Further, as illustrated in FIG. 23, the battery cell 102 demonstrates better capacity retention during charging at all measured rates compared battery cells 104 and 106. As such, based on the charging and discharging data presented in the graphs 98 and 100 of FIGS. 22 and 23, it is presently recognized that certain ratios of materials in the active layer 66 of the LTO anode 64 (e.g., 92 wt % secondary LTO, approximately 4 wt % conductive carbon, and approximately 4 wt % binder) enable the manufacture of battery cells 30 having good electrical performance.

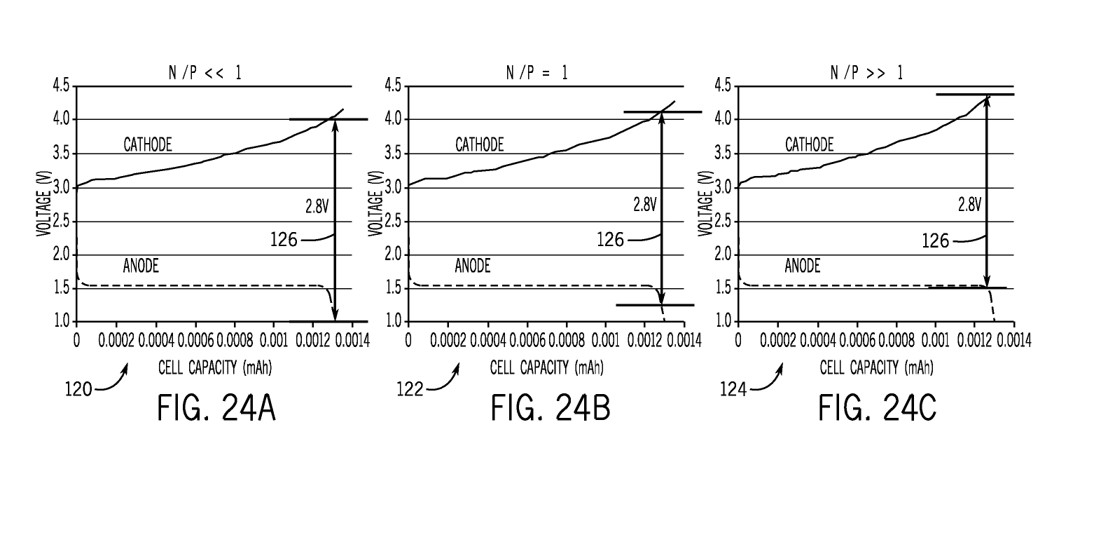

It is also presently recognized that the negative-to-positive capacity ratio (N/P) affects the electrical performance of the resulting battery cell 30. For example, FIGS. 24A, 24B, and 24C include cathode and anode voltage curves (i.e., voltage (V) vs. cell capacity (mAh)) for embodiments of battery cells 30 in which the N/P is greater than 1, equal to 1, and less than 1, respectively. Each of the graphs 120, 122, and 124 of FIGS. 24A, 24B, and 24C include a line 126, whose position indicates the relative voltage of the cathode and the anode that yields the desired 2.8 V battery cell voltage.

It is presently recognized that, as illustrated by the graph 120 in FIG. 24A, when N/P is substantially less than 1 for an embodiment of the battery cell 30, the cell may have advantages in terms of low cathode potential during charging and consistent performance throughout the life of the cell, but may also have disadvantages in terms of capacity, energy density, and average voltage. It is further recognized that, as illustrated by the graph 124 in FIG. 24C, when N/P is substantially greater than 1 for an embodiment of the battery cell 30, the cell may have advantages in terms of maximizing the usable energy of the cathode, high average voltage, and consistent charging potential at the cathode, but may also have disadvantages in terms of high charging potential at the cathode and steadily diminishing performance over the life of the cell.

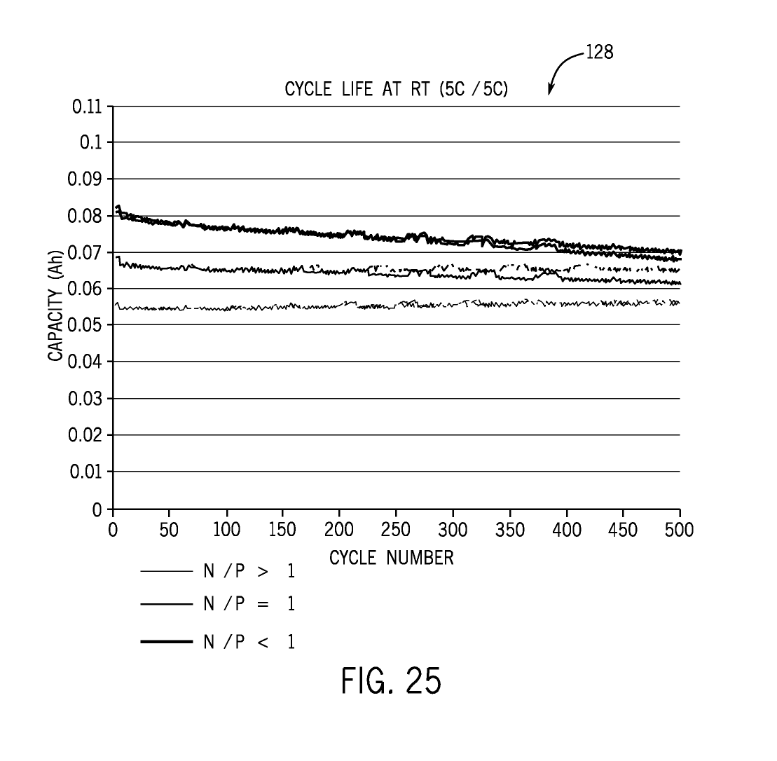

As illustrated by the graph 122 in FIG. 24B, when N/P is equal or approximately equal, then the cut-off potential of the cathode may be difficult to control. However, it is presently recognized that an embodiment of the battery cell 30 having N/P approximately equal to 1 affords a compromise between the disadvantages that result from N/P<1 and N/P>1 in terms of calendar life and cathode potential. For example, the graph 128 of FIG. 25 illustrates cycle life data for an embodiments of the battery cell 30 having N/P<1, N/P>1, and N/P=1. Accordingly, the embodiment of the battery cell 30 having N/P=1 demonstrates relatively steady performance (e.g., consistent capacity) over hundreds of charge/discharge cycles. Accordingly, based on the data presented in FIGS. 24 and 25, it is presently recognized that maintaining an N/P ratio between approximately 1.0 and approximately 1.05 enables the production of battery cells 30 having both high capacity and good cycling performance.

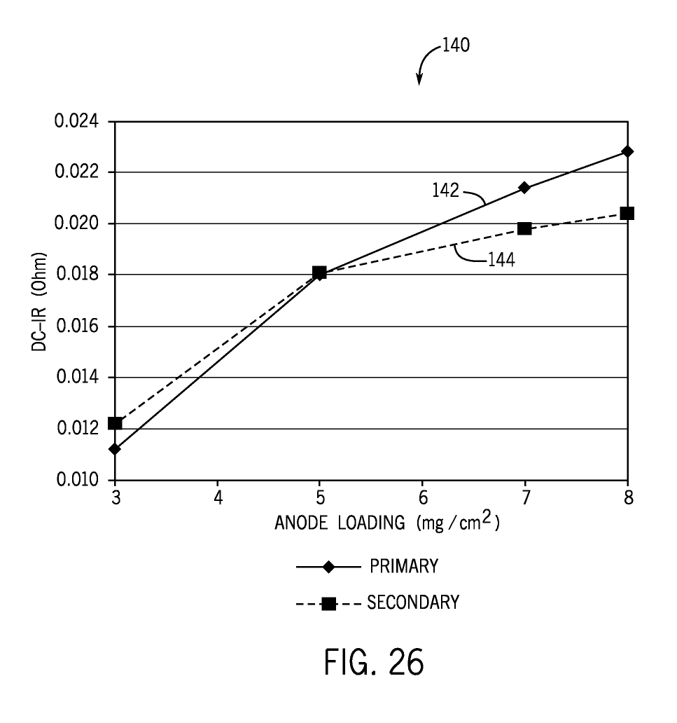

As mentioned above, the loading of the LTO anode active material (i.e., milligrams of active layer per square centimeter of anode) also affects the electrical performance of the resulting battery cell 30. For example, the graph 140 of FIG. 26 illustrates internal resistance at constant current (DC-IR in Ohms) versus the anode loading (mg/cm²) for an embodiment of a battery cell 142 made using a primary LTO (i.e., LTO4) and an embodiment of a battery cell 144 made using a secondary LTO (i.e., LTO7). As shown in FIG. 26, the battery cell 144 with secondary LTO demonstrates slightly higher resistance than the battery cell 142 with primary LTO at loading weights below 5 mg/cm². However, the battery cell 144 with secondary LTO demonstrates substantially lower resistance than the battery cell 142 at loading weights greater than 5 mg/cm². This lower resistance at higher loading is believed to be, at least in part, due to the increase porosity of the LTO active layer 66, as illustrated in FIGS. 9 and 10. Accordingly, based on the impedance data presented in the graph 140 of FIG. 12, it is presently recognized that having a LTO anode with a loading greater than 5 mg/cm² (e.g., between 5 and 10 mg/cm², between 5 and 7 mg/cm²) enables the manufacture of battery cells 30 having improved energy and power density.

Manufacturing LTO Anode

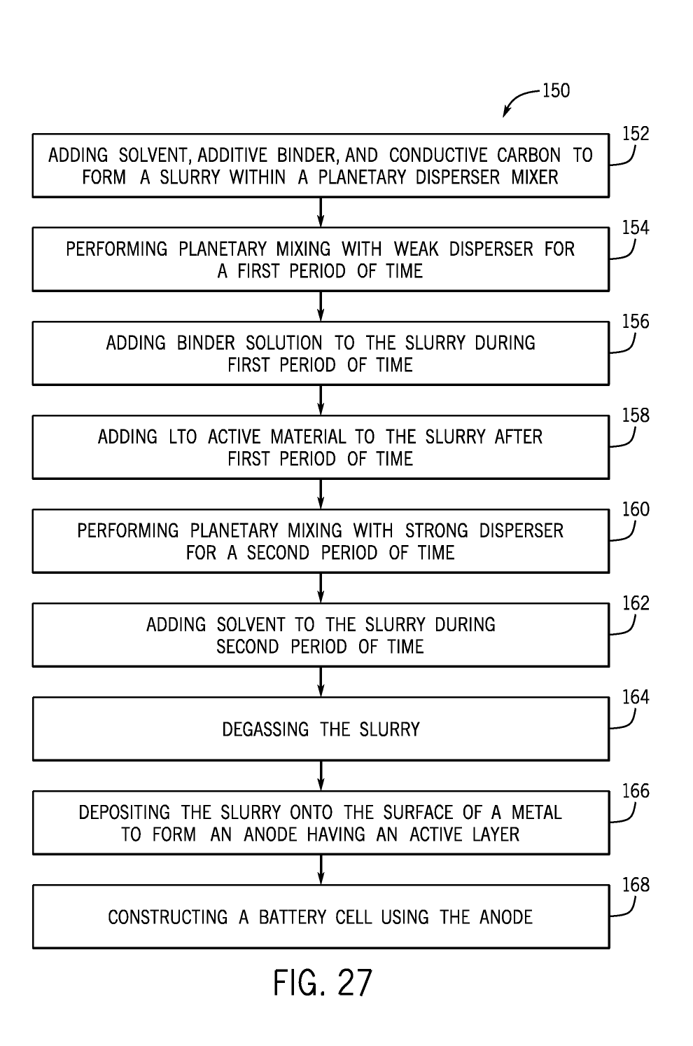

FIG. 27 is a flow diagram illustrating an embodiment of a process 150 for manufacturing a LTO anode 64, as illustrated in FIGS. 9 and 10. The illustrated process 150 generally involves the preparation of a slurry that is subsequently applied to (e.g., coated or loaded onto) the surface of a metal strip or plate (e.g., an aluminum strip or plate) to yield an anode for use in the construction of a lithium ion battery cell 30. For the embodiment illustrated in FIG. 27, the slurry preparation portion of the process 150 is described in the context of using a planetary disperser mixer with particular mixing/dispersing at various steps; however, in other embodiments, other types of mixers or modified mixing procedures may be used without negating the effect of the present approach.

The process 150 illustrated in FIG. 27 begins with adding (block 152) solvent, additive binder (e.g., a polyvinylidene fluoride (PVDF) binder), and conductive carbon (e.g., carbon black) to form a slurry within a planetary disperser mixer. Next, the mixer performs (block 154) planetary mixing of the slurry (with weak disperser) for a first period of time. Further, as indicated by block 156, during the first period of time, a binder solution (e.g., a solution including one or more PVDF binders) may be added to the slurry. In certain embodiments, the operation of the mixer may be temporarily paused for the addition of the binder solution. Furthermore, in certain embodiments, the planetary mixing and/or disperser settings may be varied (e.g., increased or decreased) throughout the first period of time.

As illustrated in FIG. 27, after the first period of time is complete, the LTO active material (e.g., the secondary LTO) may be added (block 158) to the slurry. Next, the mixer performs (block 160) planetary mixing of the slurry (with strong disperser) for a second period of time. Further, as indicated by block 162, during this second period of time, additional solvent may be added to the slurry. In certain embodiments, the mixer may be temporarily paused for the addition of the solvent represented by block 162. Furthermore, in certain embodiments, the planetary mixing and/or disperser settings may be varied (e.g., increased or decreased) throughout the second period of time.

After the second period of time is complete, the slurry may then be degassed (block 164) using vacuum and/or inert gas bubbling. In certain embodiments, the mixer may continue to provide planetary mixing to the mixture throughout the degassing represented by block 164. Subsequently, the degassed slurry may be deposited (block 166) onto the surface of a metal foil to form the active layer of an anode. For example, the degassed slurry may be deposited onto the surface of an aluminum metal foil, for example, using a die coating or reverse roll coating process, to form the active layer 66 of a LTO anode 64. Finally, the LTO anode 64 formed in block 166 may be used to construct (block 168) a lithium ion battery cell 30 capable of providing the electrical performance described above.

### Example: Manufacturing LTO Anode

In an example embodiment of the process 150 illustrated in FIG. 27, 1.2 L of N-methyl-2-pyrrolidone (NMP) solvent, 250 mL of a first polyvinylidene fluoride (PVDF) binder (e.g., BM730H available from the Zeon Corporation, Japan) referred to as the additive binder, and 100 mL of carbon black (e.g., C65 available from Timcal Graphite & Carbon, Inc. of Westlake, Ohio) are added together to form a slurry in a planetary disperser mixer, as represented by block 152. The slurry then undergoes planetary mixing with weak disperser for 60 min, as represented by block 154. At the 30 minute mark, the mixer may be paused and a binder solution added to the slurry, as represented by block 156. For this example, the binder solution includes 1 kg of the first PVDF binder (e.g., BM730H) and 250 g of a second PVDF binder (e.g., HSV900 available from Arkema, France) dissolved in 1150 mL of NMP. After adding the binding solution to the slurry, the remaining 30 min of mixing/dispersing represented by block 154, are completed.

Continuing through the example embodiment, next 2.3 kg of secondary LTO active material (e.g., LTO7) is added to the slurry, as represented by block 158, along with an additional 650 mL of NMP. The slurry then undergoes planetary mixing with strong disperser for 150 min, as represented by block 160. At the 30 minute mark, the mixer is paused and 300 mL of NMP is added to the slurry, as represented by block 162, before the remaining 120 min of mixing/dispersing represented by block 160 are completed. The slurry is subsequently placed under a vacuum as mixing/dispersing continues for an additional 30 minutes to degas the slurry, as represented by block 164.

For this example, the resulting secondary LTO slurry has a total solid ratio of approximately 43% and a viscosity of approximately 1050 centipoise (cps). For comparison, when an example primary LTO slurry is prepared using the process 150 with the substitution of a primary LTO material (e.g., LTO4) in block 158, the total mixing time is approximately 15% longer, and the resulting primary LTO slurry has a lower total solid ratio (i.e., 38%) and a higher viscosity (i.e., 1080 cps). As such, it is presently recognized that the higher solid ratio and the lower viscosity slurry of the secondary LTO slurry enables the slurry to be more easily formed and coated onto the surface of the metal foil, as represented by block 166. Furthermore, as set forth above, the improved processability of the secondary LTO slurry leads to the formation of anodes with high loading (e.g., greater than 5 mg/cm²) and good electrical performance.

### Example: Battery Cell Designs

With the forgoing in mind, Table 2 includes design parameters for three example embodiments of the pouch battery cell 30, as illustrated in FIG. 3, each including LTO anodes 64 manufactured according to the process 150 illustrated in FIG. 27 using secondary LTO. More specifically, the anode active layers 66 of each of the example LTO battery cell embodiments represented in Table 2 includes: 92 % secondary LTO (i.e., LTO7), 4 wt % conductive carbon (i.e., carbon black), and 4 wt % binder (i.e., two PVDF binders, BM730H to HSV900 at a ratio of approximately 4 to 1). Other LTO battery cell embodiments may include between approximately 90% and approximately 94% secondary LTO, between approximately 3 wt % and approximately 5 wt % conductive carbon, and between approximately 3 wt % and approximately 5 wt % binder. Additionally, in certain embodiments, the ratio of two PVDF binders (e.g., BM730H and HSV900) may be between approximately 3 to 1 and approximately 5 to 1 within the anode active layers 66.

It may be appreciated that the three example embodiments of the battery cell 30 represented in Table 2 each have different active material loadings (i.e., for both the cathode and anode) and each have a capacity around approximately 8 Ah. To maintain similar capacity while accommodating different active material loadings, the LTO battery cell embodiments represented in Table 2 have an increasing number of layers (i.e., cathode layers, anode layers, separator layers) in the stack with decreasing anode loading. Since the thickness 42 of the pouch battery cell 30, as illustrated in FIG. 3, is proportional to the number of layers in the stack, embodiments of the pouch battery cell 30 having lower active material loading are generally thicker and, therefore, have a greater volume, as represented in Table 2.

TABLE 2
Electrode compositions, cell dimensions, and performance for three different
embodiments of the pouch battery cell 30 having either high, medium, or low
electrode loading.

| | | | | | Medium | | | |
|---|---|---|---|---|---|---|---|---|
| | | | High loading | | loading | | Low loading | |
| | | Unit | Cathode | Anode | Cathode | Anode | Cathode | Anode |
| Electrode | Loading | mg/cm² | 6.4 | 6.8 | 5 | 5.4 | 3.2 | 3.4 |
| | Thickness | μm | 69.2 | 95.6 | 59.2 | 80 | 44.6 | 57.8 |
| | Width | mm | 107 | 109 | 107 | 109 | 107 | 109 |
| | Height | mm | 191 | 195 | 191 | 195 | 191 | 195 |
| | Density | g/cc | 2.6 | 1.8 | 2.6 | 1.8 | 2.6 | 1.8 |
| | Layers | n | 23 | 24 | 30 | 31 | 46 | 47 |
| | Area | cm² | 9401 | 9777 | 12262 | 12753 | 18802 | 19555 |

| Cell | Capacity | Ah | 8.1 | 8.2 | 8.1 |
|---|---|---|---|---|---|
| | Cell Thickenss | mm | 5.28 | 6.14 | 7.1 |
| | Width | mm | 130 | | |
| | Length | mm | 234 | | |
| | Volume | L | 0.161 | 0.187 | 0.216 |
| Performance | Power | W | 955 | 1135 | 1525 |
| | Power density | W/L | 5933 | 6071 | 7059 |

As illustrated in Table 2, the disclosed secondary LTO active materials enable greater freedom in the design of both anodes 64 and battery cells 30, compared to primary LTO active materials. That is, since the secondary LTO active material enables anode loading beyond 5 mg/cm², embodiments of the pouch battery cell 30 may be manufactured to provide similar capacity using a smaller stack (e.g., fewer cathode/anode layers, a thinner “jelly-roll” with fewer rolls). Since a fewer cathode/anode layers may be used while maintaining a similar capacity, embodiments of the battery cell 30 with higher anode loading (e.g., greater than 5 mg/cm²) may be cheaper to manufacture and/or may enable a weight reduction for the battery cell 30. Additionally, although a larger stack is used (e.g., greater than 25 anode layers) for the embodiments represented in Table 2 with the lower anode loading, these embodiments also demonstrate higher power density, which may be useful to particular applications involving higher charging/discharging rates. As such, the disclosed secondary LTO materials, anode designs, and battery cell designs enable greater freedom in production of different types of lithium ion of battery cells based on desired cost, dimensions, application, and so forth.

One or more of the disclosed embodiments, alone or on combination, may provide one or more technical effects including the manufacture of battery modules having LTO anodes made using secondary LTO particles. The technical effects and technical problems in the specification are exemplary and are not limiting. It should be noted that the embodiments described in the specification may have other technical effects and can solve other technical problems. The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A battery module, comprising:
a lithium ion battery cell, comprising:
a cathode having a cathode active layer, and
an anode having an anode active layer, comprising:
at least one polyvinylidene fluoride (PVDF) binder;
a conductive carbon; and
a secondary lithium titanate oxide (LTO), wherein the secondary LTO comprises secondary LTO particles having an average particle size (D₅₀) greater than 2 micrometers (μm).

2. The battery module of claim 1, wherein the secondary LTO particles are agglomerates of primary LTO particles, and wherein the primary LTO particles have an average particles size (D₅₀) less than approximately 250 nanometers (nm) before agglomeration.

3. The battery module of claim 1, wherein the average particle size (D₅₀) of the secondary LTO particles is between approximately 3 μm and approximately 20 μm.

4. The battery module of claim 1, wherein the anode has a loading between approximately 5 milligrams (mg) and approximately 10 mg of the anode active layer per square centimeter (cm²) of the anode.

5. The battery module of claim 1, wherein the cathode active layer includes a nickel magnesium cobalt (NMC)-based material comprising nickel, magnesium, and cobalt and having a layered structure, and wherein the secondary LTO comprises lithium, titanium, and oxygen and has a spinel structure.

6. The battery module of claim 1, wherein lithium ion battery cell comprises a plurality of layers of the anode, wherein the plurality of layers of the anode each have a thickness less than approximately 100 μm.

7. The battery module of claim 1, wherein a density of the anode active layer is approximately 1.8 grams per cubic centimeter (g/cc).

8. The battery module of claim 1, wherein the lithium ion battery cell has an internal resistance (DC-IR) less than approximately 0.021 Ohms.

9. The battery module of claim 1, wherein a capacity retention of the lithium ion battery cell decreases by less than approximately 5% after 400 cycles at 10 C.

10. The battery module of claim 9, wherein the capacity retention of the lithium ion battery cell is greater than approximately 90% after 400 cycles at 10 C.

11. The battery module of claim 1, wherein the lithium ion battery cell has a first capacity retention and a first recovery at the time of manufacturing and has a second capacity retention and a second recovery after 1 month at 60° C., wherein the second capacity retention is greater than approximately 60% of the first capacity retention, and wherein the second recovery is greater than approximately 80% of the first recovery.

12. The battery module of claim 1, wherein the lithium ion battery cell has a first capacity retention at room temperature and a second capacity retention at −20° C., wherein the second capacity retention is greater than or equal to approximately 60% of the first capacity retention.

13. The battery module of claim 1, wherein the lithium ion battery cell has a first area-specific impedance (ASI) at the time of manufacturing and a second ASI after 1 month at 60° C., wherein the second ASI is less than approximately 50% larger than the first ASI.

14. The battery module of claim 13, wherein the first ASI is less than approximately 16 Ohm centimeters squared (Ohm·cm²), and wherein the second ASI is less than approximately 24 Ohm·cm².

15. The battery module of claim 1, wherein the lithium ion battery cell has first ASI at the time of manufacturing and a second ASI after 1 week at 60° C., wherein an average lithiation component of the second ASI is less than approximately 50% larger than an average lithiation component of the first ASI, and wherein an average delithiation component of the second ASI is less than approximately 50% larger than an average dilithiation component of the first ASI.

16. The battery module of claim 1, wherein the lithium ion battery cell has a negative-to-positive capacity ratio (N/P) between approximately 1.0 and approximately 1.05.

17. The battery module of claim 1, wherein the battery module comprises a second battery cell, and wherein the second battery cell comprises a lead-acid battery.

18. The battery module of claim 1, wherein the battery module comprises a battery control module that monitors and controls operation of the battery module, wherein the battery control module is configured to communicate with a vehicle control unit of a micro-hybrid xEV.

19. A method of manufacturing a lithium ion battery cell, comprising:
forming a slurry comprising a solvent, a conductive carbon, at least one binder, and a secondary LTO active material, wherein the secondary LTO active material comprises secondary LTO particles having an average particle size (D₅₀) greater than 2 micrometers (μm);
depositing the slurry onto the surface of a metal to form the active layer of an anode; and
assembling the lithium ion battery cell using the anode.

20. The method of claim 19, wherein forming the slurry comprises:
forming a mixture that includes the solvent, the conductive carbon, and a first binder;
adding a binder solution to the mixture, wherein the binder solution comprises the first binder and a second binder; and
adding the secondary LTO active material to the mixture to form the slurry.

21. The method of claim 20, wherein a ratio between the first binder and the second binder in the binder solution is approximately 4 to 1.

22. The method of claim 19, wherein the solvent comprises N-methyl-2-pyrrolidone (NMP), the conductive carbon comprises carbon black, and the binder comprises a first polyvinylidene fluoride (PVDF) binder and a second PVDF binder.

23. The method of claim 22, wherein the active layer comprises between approximately 90 wt % and approximately 94 wt % of the secondary LTO active material, between approximately 3 wt % and approximately 5 wt % of the first and the second PVDF binders, and between approximately 3 wt % and 5 wt % of the carbon black, and wherein a ratio of the first PVDF binder to the second PVDF binder is between approximately 5 to 1 and approximately 3 to 1.

24. The method of claim 23, wherein the anode active layer comprises 92 wt % of the secondary LTO active material, 4 wt % of the first and the second PVDF binders, and 4 wt % of the carbon black, wherein the ratio of the first PVDF binder to the second PVDF binder is approximately 4 to 1.

25. The method of claim 19, comprising degassing the slurry under reduced pressure before depositing the slurry onto the surface of the metal.

26. The method of claim 25, wherein the slurry has a total solid ratio greater than approximately 38% and a viscosity that is less than approximately 1080 centipoise (cps).

27. A lithium ion battery cell, comprising:
an electrode stack, comprising:
a cathode having a cathode active layer;
an anode having a loading of at least 5 milligrams (mg) of anode active layer per square centimeter (cm²) of anode, wherein the anode active layer comprises:
at least one polyvinylidene fluoride (PVDF) binder;
a conductive carbon; and
a secondary lithium titanate oxide (LTO), wherein the secondary LTO comprises secondary LTO particles having an average particle size (D₅₀) greater than 2 micrometers (μm).

28. The system of claim 27, wherein the secondary LTO particles are agglomerates of primary LTO particles, wherein the primary LTO particles have an average particles size (D₅₀) less than approximately 250 nm before agglomeration, and wherein the average particle size (D₅₀) of the secondary LTO particles is between approximately 3 μm and approximately 20 μm.

29. The system of claim 27, wherein the lithium ion battery cell has an internal resistance (DC-IR) less than approximately 0.021 Ohms.

30. The system of claim 27, wherein the lithium ion battery cell is a pouch battery cell, and wherein the electrode stack comprises the anode, the cathode, and at least one separator rolled together around a common axis.

31. The system of claim 27, wherein the lithium ion battery cell has a capacity greater than approximately 8 ampere hours (Ah).

32. The system of claim 31, wherein the lithium ion battery cell has a thickness less than or equal to approximately 7.1 mm and a volume less than or equal to approximately 0.22 liters (L).

33. The system of claim 32, wherein the electrode stack comprises less than 50 layers of the anode and less than 50 layers of the cathode, and wherein the lithium ion battery cell has a power density greater than approximately 7000 Watts per liter (W/L).

34. The system of claim 31, wherein the lithium ion battery cell has a thickness less than or equal to approximately 6.1 mm and a volume less than or equal to approximately 0.19 L.

35. The system of claim 34, wherein the electrode stack comprises less than 32 layers of the anode and less than 32 layers of the cathode, and wherein the lithium ion battery cell has a power density that is greater than approximately 6000 W/L.

36. The system of claim 31, wherein the lithium ion battery cell has a thickness less than or equal to approximately 5.3 mm and a volume less than or equal to approximately 0.16 L.

37. The system of claim 36, wherein the electrode stack comprises less than 25 layers of the anode and less than 25 layers of the cathode, and wherein the lithium ion battery cell has a power density that is greater than approximately 5900 W/L.
